(19) United States
(12) Patent Application Publication
(10) Pub. No.: US 2024/0341219 A1
(43) Pub. Date: Oct. 17, 2024

(54) HAND RAKE

(71) Applicant: Allen Bownds, Shallowater, TX (US)

(72) Inventor: Allen Bownds, Shallowater, TX (US)

(21) Appl. No.: 18/133,599

(22) Filed: Apr. 12, 2023

(51) Int. Cl. A01D 7/06

(52) U.S. Cl. CPC A01D 7/06

(57) ABSTRACT

A rake apparatus for moving debris, such as leaves or other yard waste, from the ground includes a body which is elongated from a first end to a second end of the body. A plurality of tines is coupled to and extends away from the first end of the body. A handle is coupled to a rear surface of the body adjacent to the second end of the body. A method of using two rake apparatuses in conjunction with each other to move debris is also claimed.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to lawn tools and more particularly pertains to a new lawn tool for moving debris, such as leaves or other yard waste, from the ground.

### (2) Description of Related Art Including Information Disclosed Under 37 CFR 1.97 and 1.9

The prior art discloses several rakes and similar lawn tools for moving debris like leaves from the ground. Conventional lawn rakes typically have a long handle so that the user of the rake may grasp the handle with two hands and move the rake in a sweeping motion while standing generally upright to rake a lawn. These lawn rakes are effective at moving leaves into a pile, but it is a cumbersome task to try to use such rakes to pick leaves or other debris up once it is in the pile to place into a bag, bin, or similar for disposal. This is because such lawn rakes are not structured to grasp the leaves and they have a size and shape that makes it difficult to grasp the debris between two rakes or between a rake and a hand.

The prior art discloses several hand-worn rake-like tools to combat this problem. A user wearing such a hand-worn tool may be able to more effectively pick up debris from a pile on the ground using rake tines, webbing, or the like to grasp more debris between his/her hands than he/she would otherwise be able to do without the tool. However, the prior art does not disclose a tool with a handle attached to the back of a rake body such that a user can perform a grasping action on a large pile of debris without encumbering his/her hands with a tool that encloses the user's hands. Additionally, such a device could have loops attached to the handle which engage the user's arms to avoid strain to wrist joints and limit the muscular effort required of the user.

### (h) BRIEF SUMMARY OF THE INVENTION

An embodiment of the disclosure meets the needs presented above by generally comprising a body which is elongated from a first end to a second end of the body. A plurality of tines is coupled to and extends away from the first end of the body. A handle is coupled to a rear surface of the body adjacent to the second end of the body.

Another embodiment of the disclosure includes a method comprising positioning a first arm of a user in a loop of a first rake apparatus. The user grasps a grip of a handle of the first rake apparatus with a first hand connected to the first arm. The user positions a second arm of the user in a loop of a second rake apparatus and grasps a grip of a handle of the second rake apparatus with a second hand connected to the second arm. The user moves the first and second rake apparatuses toward each other with the first and second hands to clamp the debris between a plurality of tines of the first and second rake apparatuses. The handle of the first and second rake apparatuses is positioned between the loop and the plurality of tines of the first and second rake apparatuses respectively. By moving the first and second rake apparatuses as described, the loop of the first and second rake apparatuses engages the first and second arm respectively to inhibit rotation of the first and second rake apparatuses relative to the first and second arms respectively. The user moves the first and second rake apparatuses away from the ground surface to lift the debris, places the debris in a selected location, and moves the first and second rake apparatuses away from each other to unclamp the debris.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a rake apparatus according to an embodiment of the disclosure.

FIG. 2 is a rear view of an embodiment of the disclosure.

FIG. 3 is a front view of an embodiment of the disclosure.

FIG. 4 is a side view of an embodiment of the disclosure.

FIG. 5 is a perspective in-use view of an embodiment of the disclosure.

FIG. 6 is an in-use view of two iterations of an embodiment of the disclosure.

### (j) DETAILED DESCRIPTION OF THE INVENTION

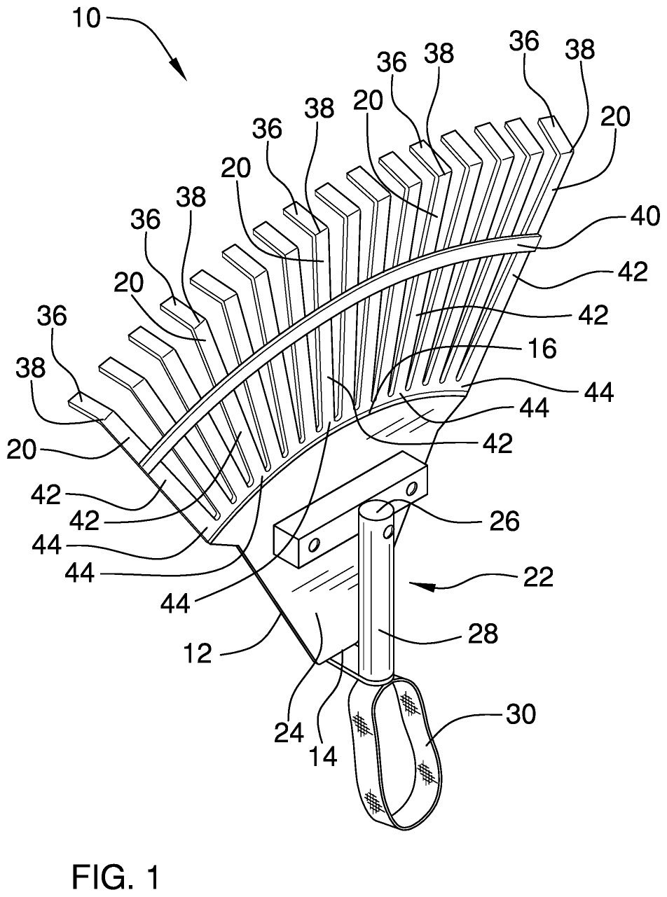

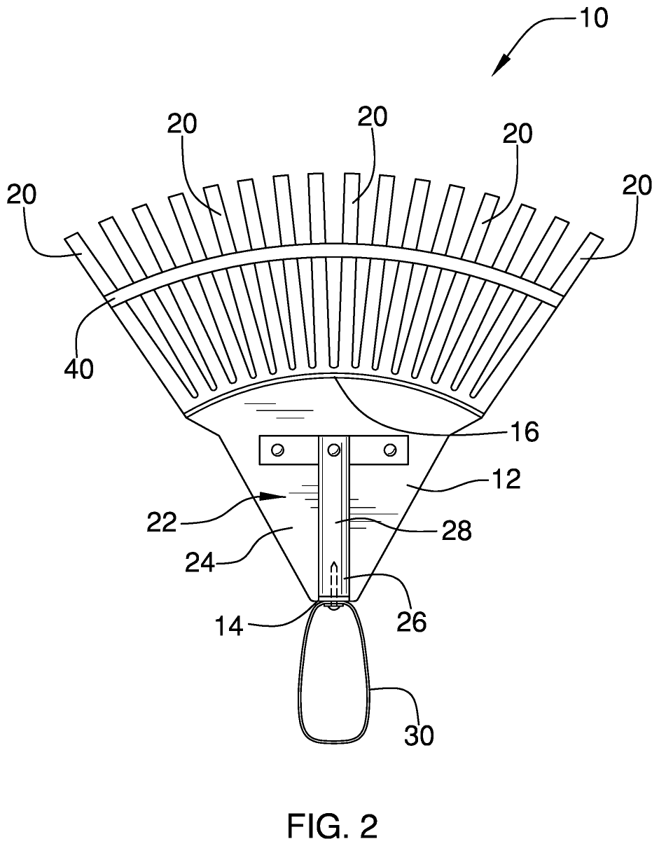

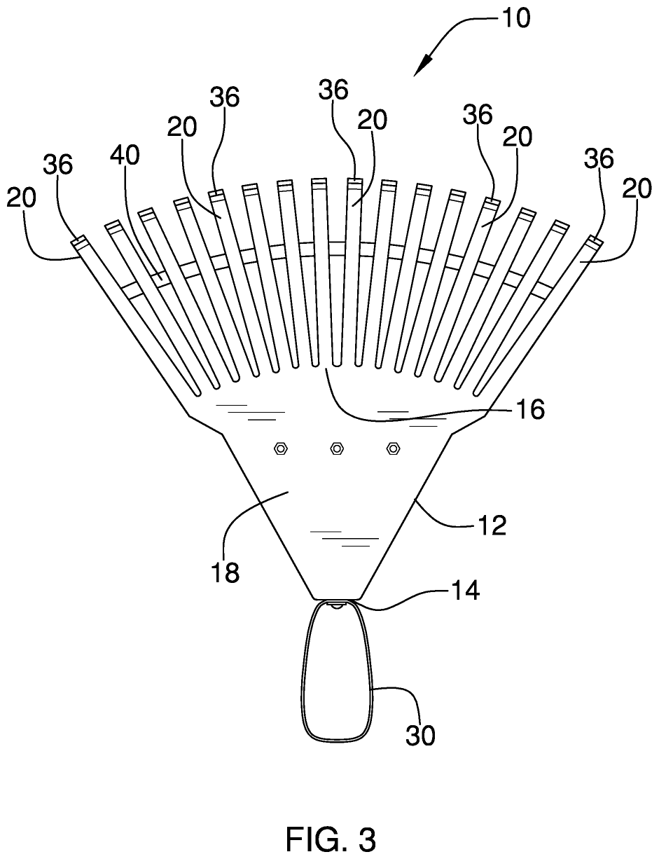

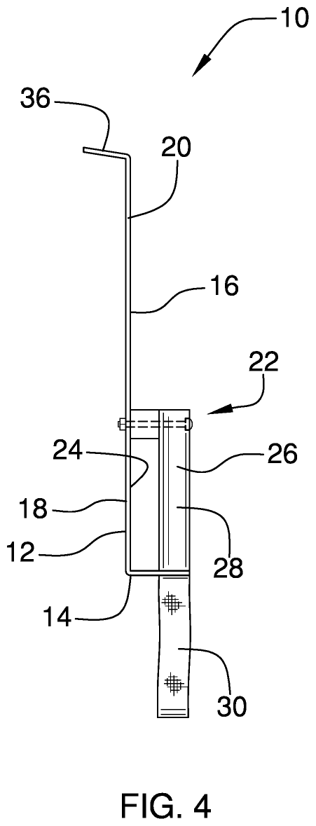

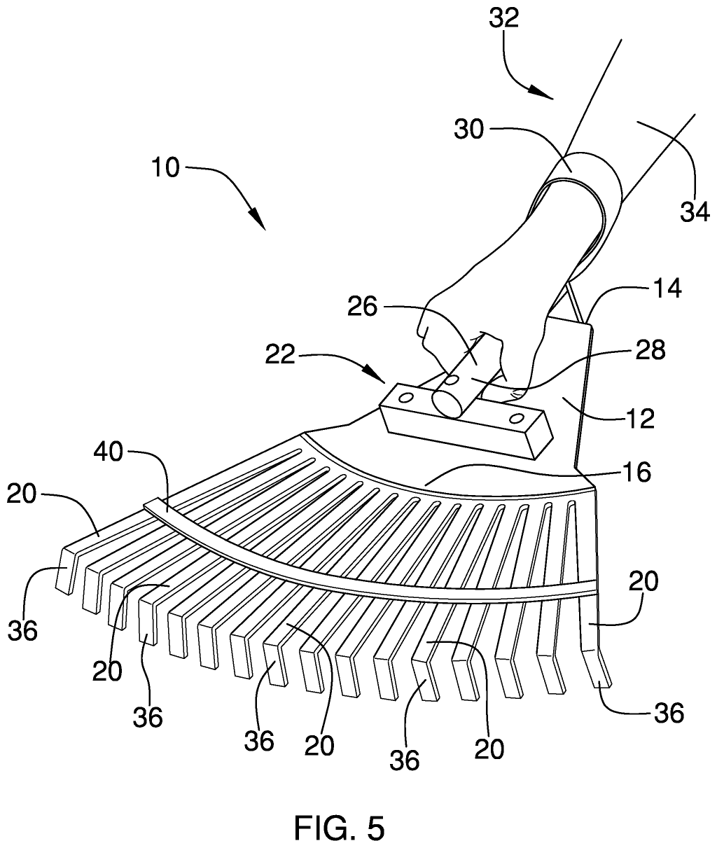

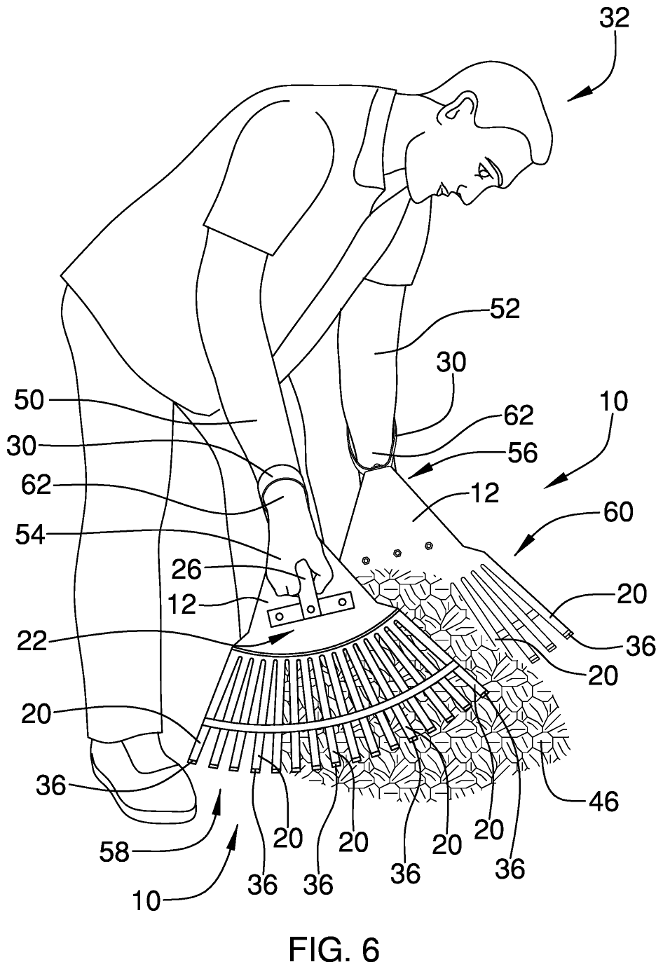

With reference now to the drawings, and in particular to FIGS. 1 through 6 thereof, a new lawn tool embodying the principles and concepts of an embodiment of the disclosure and generally designated by the reference numeral 10 will be described.

As best illustrated in FIGS. 1 through 6, the rake apparatus 10 generally comprises a body 12 which is elongated from a first end 14 to a second end 16 of the body 12. The body 12 has a planar front surface 18 extending from the first end 14 to the second end 16 of the body 12. A plurality of tines 20 is coupled to and extends away from the first end 14 of the body 12. The plurality of tines 20 is coplanar with each other, and each tine 20 of the plurality of tines 20 extends radially away from the body 12. The plurality of tines 20 is also coplanar with the planar front surface 18 of the body 12.

A handle 22 is coupled to a rear surface 24 of the body 12 adjacent to the second end 16 of the body 12. The handle 22 comprises a grip 26 which is spaced rearwardly with respect to the body 12. The grip 26 is elongated and is oriented parallel to a central longitudinal axis of the body 12. The grip 26 has a cylindrical outer surface 28. A loop 30 is coupled to a second end 16 of the handle 22, and the loop 30 has a size such that the loop 30 is configured for receiving an arm 34 of a user 32. The loop 30 comprises a flexible fabric material so that the loop 30 may conform to a shape of the arm 34 to distribute force applied to the arm 34 by the loop 30 during use.

Each tooth 36 of a plurality of teeth 36 is coupled to a respective tine 20 of the plurality of tines 20. Each tooth 36 of the plurality of teeth 36 is positioned on a distal end 38 of the respective tine 20 relative to the body 12 and extends forwardly with respect to the respective tine 20. A brace 40 is coupled to a rear side 42 of each tine 20 of the plurality of tines 20 for limiting deflection of the plurality of tines 20 relative to each other. The brace 40 is positioned between a proximal end 44 of each tine 20 of the plurality of tines 20 with respect to the body 12 and the distal end 38 of each tine 20 of the plurality of tines 20.

In use, the user 32 uses two rake apparatuses 10 to pick up debris 46, such as leaves, twigs, litter, or the like, from a ground surface and move the debris 46 to a selected location. The user 32 positions a first arm 50 of the user 32 in the loop 30 of a first rake apparatus 58 and positions a second arm 52 of the user 32 in the loop 30 of a second rake apparatus 60. The user 32 grasps the grip 26 of the handle 22 of the first rake apparatus 58 with a first hand 54 connected to the first arm 50 and grasps the grip 26 of the handle 22 of the second rake apparatus 60 with a second hand 56 connected to the second arm 52.

The user 32 then moves the first and second rake apparatuses 58, 60 toward each other to clamp the debris 46 between the plurality of tines 20 of each of the first and second rake apparatuses 58, 60. By moving the rake apparatuses 10 in this way, the first and second rake apparatuses 58, 60 may be urged by the debris 46 to rotate relative to the first and second arms 50, 52 respectively. The loop 30 of the first and second rake apparatuses 58, 60 act to resist this rotation by engaging the first and second arms 50, 52 respectively, thereby relieving pressure that would be exerted on the user's 32 wrists 62 and requiring less muscular effort by the user 32 to resist the rotation.

The user 32 then moves the first and second rake apparatuses 58, 60 away from the ground surface to lift the debris 46, places the debris 46 in the selected location, and moves the first and second rake apparatuses 58, 60 away from each other to unclamp the debris 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rake apparatus for moving debris positioned on a ground surface, the apparatus comprising:
a body being elongated from a first end to a second end of the body;
a plurality of tines being coupled to and extending away from the first end of the body; and
a handle being coupled to a rear surface of the body adjacent to the second end of the body.

2. The apparatus of claim 1, wherein the body has a planar front surface extending from the first end to the second end of the body, the plurality of tines being coplanar with the planar front surface of the body.

3. The apparatus of claim 1, wherein the plurality of tines is coplanar with each other, each tine of the plurality of tines extending radially away from the body.

4. The apparatus of claim 1, wherein the handle comprises a grip, the grip being spaced rearwardly with respect to the body.

5. The apparatus of claim 4, wherein the grip is elongated and is oriented parallel to a central longitudinal axis of the body.

6. The apparatus of claim 4, wherein the grip has a cylindrical outer surface.

7. The apparatus of claim 1, further comprising a loop being coupled to a second end of the handle, the loop having a size such that the loop is configured for receiving an arm of a user.

8. The apparatus of claim 7, wherein the loop comprises a flexible fabric material such that said loop is configured for conforming to a shape of the arm.

9. The apparatus of claim 1, further comprising a plurality of teeth, each tooth of the plurality of teeth being coupled to a respective tine of the plurality of tines, each tooth of the plurality of teeth being positioned on a distal end of the respective tine relative to the body, each tooth of the plurality of teeth extending forwardly with respect to the respective tine.

10. The apparatus of claim 1, further comprising a brace being coupled to a rear side of each tine of the plurality of tines for limiting deflection of the plurality of tines relative to each other, the brace being positioned between a proximal end of each tine of the plurality of tines with respect to the body and the distal end of each tine of the plurality of tines.

11. A rake apparatus for moving debris positioned on a ground surface, the apparatus comprising:
a body being elongated from a first end to a second end of the body, the body having a planar front surface extending from the first end to the second end of the body;
a plurality of tines being coupled to and extending away from the first end of the body, the plurality of tines being coplanar with each other, each tine of the plurality of tines extending radially away from the body, the plurality of tines being coplanar with the planar front surface of the body;
a handle being coupled to a rear surface of the body adjacent to the second end of the body, the handle comprising a grip, the grip being spaced rearwardly with respect to the body, the grip being elongated and being oriented parallel to a central longitudinal axis of the body, the grip having a cylindrical outer surface;
a loop being coupled to a second end of the handle, the loop having a size such that the loop is configured for receiving an arm of a user, the loop comprising a flexible fabric material such that said loop is configured for conforming to a shape of the arm;
a plurality of teeth, each tooth of the plurality of teeth being coupled to a respective tine of the plurality of tines, each tooth of the plurality of teeth being positioned on a distal end of the respective tine relative to the body, each tooth of the plurality of teeth extending forwardly with respect to the respective tine; and
a brace being coupled to a rear side of each tine of the plurality of tines for limiting deflection of the plurality of tines relative to each other, the brace being positioned between a proximal end of each tine of the plurality of tines with respect to the body and the distal end of each tine of the plurality of tines.

12. A method of moving debris positioned on a ground surface, the method comprising:
positioning a first arm of a user in a loop of a first rake apparatus;
grasping, with a first hand connected to the first arm, a grip of a handle of the first rake apparatus;
positioning a second arm of the user in a loop of a second rake apparatus;
grasping, with a second hand connected to the second arm, a grip of a handle of the second rake apparatus;
moving, with the first and second hands, the first and second rake apparatuses toward each other to clamp the debris between a plurality of tines of the first rake apparatus and a plurality of tines of the second rake apparatus, wherein the handle of the first rake apparatus is positioned between the loop and the plurality of tines of the first rake apparatus, wherein the handle of the second rake apparatus is positioned between the loop and the plurality of tines of the second rake apparatus, whereby the loop of the first rake apparatus engages the first arm to inhibit rotation of the first rake apparatus relative to the first arm, whereby the loop of the second rake apparatus engages the second arm to inhibit rotation of the second rake apparatus relative to the second arm;
moving the first and second rake apparatuses away from the ground surface to lift the debris;
placing the debris in a selected location; and
moving, with the first and second hands, the first and second rake apparatuses away from each other to unclamp the debris.
